(19) United States
(12) Patent Application Publication
(10) Pub. No.: US 2018/0281587 A1
(43) Pub. Date: Oct. 4, 2018

(54) FUELING APPARATUS

(71) Applicant: Sumitomo Riko Company Limited, Komaki-shi (JP)

(72) Inventors: Lin JIANG, Komaki-shi (JP); Atsuo MIYAJIMA, Komaki-shi (JP); Yukinori WAKAZONO, Komaki-shi (JP); Tomoyuki FUKUYASU, Komaki-shi (JP)

(73) Assignee: Sumitomo Riko Company Limited, Komaki-shi (JP)

(21) Appl. No.: 15/995,185

(22) Filed: Jun. 1, 2018

Related U.S. Application Data
(63) Continuation of application No. PCT/JP2017/035893, filed on Oct. 3, 2017.

(30) Foreign Application Priority Data
Oct. 26, 2016 (JP) 2016-209867

(51) Int. Cl. B60K 15/04

(52) U.S. Cl. CPC B60K 15/04; B60K 2015/0464; B60K 2015/048

(57) ABSTRACT

A fueling apparatus includes a filler tube including: a fitable cylindrical portion fitted around an outer peripheral face on a filler neck's outlet side; a tapered cylindrical portion formed to have a major diameter on one of the opposite sides adjacent to the fitable cylindrical portion, and formed to have a minor diameter on the other opposite side across from the fitable cylindrical portion; and a minor-diameter cylindrical portion connected to the tapered cylindrical portion on the minor-diameter side, formed to have a minor diameter being smaller than that of the fitable cylindrical portion, and formed to have a predetermined inside diameter being set up based on a fuel distribution condition from the filler neck to the fuel tank. The filler neck is formed to have an outlet inside diameter being larger than the predetermined inside diameter in the minor-diameter cylindrical portion of the filler tube.

### CROSS REFERENCE TO RELATED APPLICATIONS

The present application is a Continuation Application of International Application No. PCT/JP2017/035893, filed on Oct. 3, 2017, which is incorporated herein by reference. The present invention is based on Japanese Patent Application No. 2016-209867, filed on Oct. 26, 2016, the entire contents of which are incorporated herein by reference.

### BACKGROUND OF THE INVENTION

### 1. Field of the Invention

The present invention relates to a fueling apparatus.

### 2. Description of the Related Art

Japanese Patent Gazette No. 5321444, Japanese Patent Publication (KOKAI) Gazette No. 2003-80959, and Japanese Patent Publication (KOKAI) Gazette No. 2004-351658 disclose a fueling apparatus comprising: a filler neck into which a nozzle of a fueling gun is inserted; and a filler tube fitted around an outlet outer peripheral face of the filler neck. The filler tube has an inside diameter which is set up based on conditions of the distribution of fuel from the filler neck to a fuel tank. For example, the inside diameter of the filler tube is set up so as to make a flow volume of the fuel, which is distributed through the filler tube, a predetermined volume or more per unit time. Moreover, the filler tube is formed so as to have a diameter, which is substantially comparable to the set-up inside diameter, over the entire length.

In addition, in order to ensure the continuity between the filler neck and the filler tube, the filler neck is formed to have an outlet-side inside diameter which is comparative to the inside diameter of the filler tube. Accordingly, the filler tube, which is fitted at one of the opposite ends around the outlet-side outer peripheral face of the filler neck, is formed to have a substantially identical inside diameter over the entire length from at around the outlet of the filler neck to another one of the opposite ends of the filler tube. Meanwhile, the filler neck is formed on an inlet side to have a larger inside diameter than that of an outlet side so as to enable the nozzle of the fueling gun to be easily inserted into the filler neck. Consequently, the filler neck is built at the intermediate part to diametrically reduce from the inlet side to the outlet side.

### SUMMARY OF THE INVENTION

Note herein that the filler tube has a configuration which can be designed freely. Moreover, the filler tube comprises a foldable or bendable part at its own suitable location in view of the relationships to its peripheral structures. However, the filler neck is formed linearly over the range from an inlet side to an outlet side. Consequently, the longer the filler neck is made, the more the layout of filler piping made up of the filler neck and filler tube is restricted.

In particular, the filler neck comprising diametrically reduced part at the intermediate part has come to have a lengthened overall length. In order to upgrade the degree of freedom in laying out the filler piping, it has been required to shorten the filler neck in the overall length.

The present invention is aimed at providing a fueling apparatus which not only allows a filler neck to have a shortened length but also permits upgrading the degree of freedom in laying out the filler piping.

A fueling apparatus directed to the present invention comprises: a filler neck which is formed as a cylindrical shape, and into which a nozzle of a fueling gun is inserted through an inlet side thereof; and a filler tube connected at one of opposite ends thereof to an outlet side of the filler neck, and connected at another one of the opposite ends to a side of a fuel tank.

The filler tube includes: a fitable cylindrical portion fitted around an outer peripheral face on the outlet side of the filler neck; a tapered cylindrical portion formed to have a major diameter on one of opposite sides thereof adjacent to the fitable cylindrical portion, and formed to have a minor diameter on another one of the opposite sides across from the fitable cylindrical portion; and a minor-diameter cylindrical portion connected to the tapered cylindrical portion on the minor-diameter side, formed to have a minor diameter which is smaller than that of the fitable cylindrical portion, and formed to have a predetermined inside diameter which is set up based on a fuel distribution condition from the filler neck to the fuel tank. Moreover, the filler neck is formed to have an outlet inside diameter which is larger than the predetermined inside diameter in the minor-diameter cylindrical portion of the filler tube.

The fueling apparatus directed to the present invention comprises the filler tube including the tapered cylindrical portion disposed between the fitable cylindrical portion and the minor-diameter cylindrical portion. That is, the present fueling apparatus has such a novel structure that is equivalent to shifting or transferring the diametrically reduced part, which the conventional filler neck includes, to a side adjacent to the conventional filler tube. Therefore, the present fueling apparatus allows the filler neck to have a shortened overall length. Moreover, even when the filler tube is made to have a linearly shaped central axis line from one of the opposite ends to the tapered cylindrical portion, the minor-diameter cylindrical portion of the filler tube permits flexing or bending the central axial line of the filler tube at around a part where the minor-diameter cylindrical portion is connected to the tapered cylindrical portion, as well as extending the central axial line linearly. That is, the present fueling apparatus allows the minor-diameter portion of the filler tube to have a free configuration over the entire length. In other words, the present fuel filler apparatus permits forming a part, which is equivalent to a minor-diameter part in the conventionally-structured filler neck, so as to be bendable or foldable. As a result, the present fueling apparatus offers an upgraded degree of freedom in laying out the filler piping.

### BRIEF DESCRIPTION OF THE DRAWINGS

FIG. 1 is a schematic diagram of a fueling apparatus 1 directed to First Embodiment;

FIG. 2 is an axial cross-sectional view of the fueling apparatus 1;

FIG. 3 is another axial cross-section view in which the fueling apparatus 1 shown in FIG. 2 is put on a fueling mode;

FIG. 4 is an axial cross-sectional view of a fueling apparatus 100 directed to Third Embodiment; and

FIG. 5 is another axial cross-section view in which the fueling apparatus 100 shown in FIG. 4 is put on a fueling mode.

### DESCRIPTION OF THE EMBODIMENTS

### 1. First Embodiment

1-1. Construction of Fueling Apparatus 1

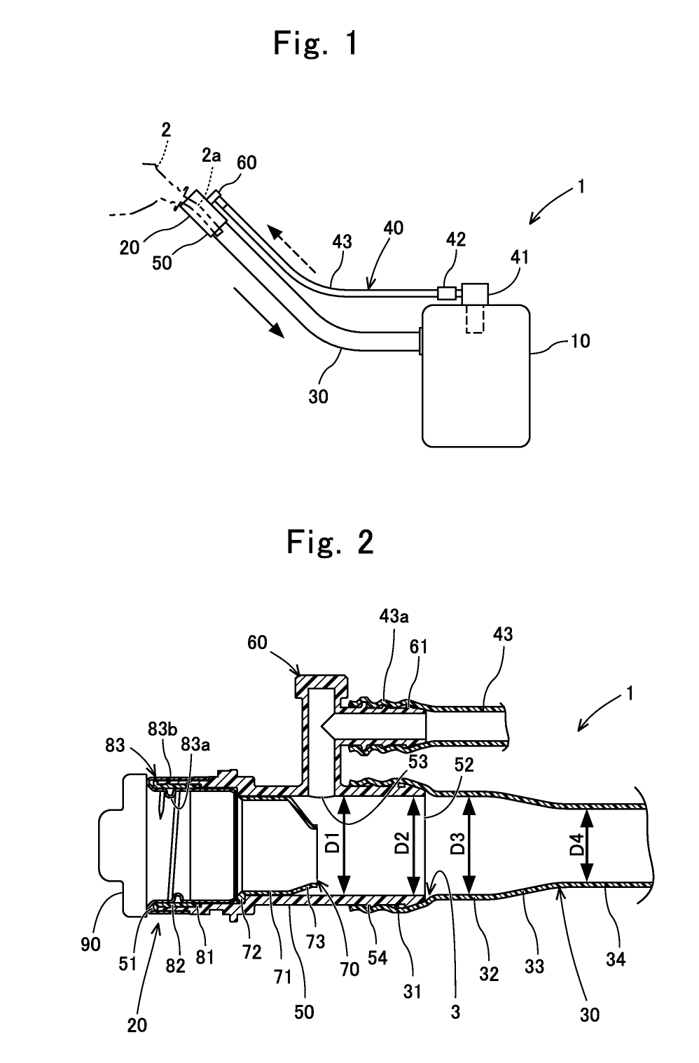

How the fueling apparatus 1 according to First Embodiment is constructed will be hereinafter described with reference to FIG. 1. The fueling apparatus 1 makes a fuel line from a filler neck 20 to an internal combustion engine (not shown) in an automobile. However, the fueling apparatus 1 according to the present embodiment will be hereinafter described while focusing on some of the fuel line from the filler neck 20, a constituent element of the fueling apparatus 1, and up to a fuel tank 10.

The fueling apparatus 1 comprises the fuel tank 10, the filler neck 20, a filler tube 30, and a breather line 40. The fuel tank 10 reserves a liquid fuel, such as gasoline, in it. The liquid fuel reserved in the fuel tank 10 is supplied to the not-shown internal combustion engine, and is used to drive it.

The filler neck 20 is disposed at around an automobile outer surface through which a nozzle 2a of a fueling gun 2 can be inserted into the filler neck 20. The filler neck 20 involves satisfactorily a type with a filler cap 90 (see FIG. 2), or involves properly another type without any filler cap. The type with the filler cap 90 exemplifies the filler neck 20 according to First Embodiment. The filler neck 20 includes: a filler-neck body 50 which is provided with an inlet and outlet, and whose axial line is formed linearly; a breather cylindrical portion 60 linked to an outer peripheral face of the filler-neck body 50; and the filler cap 90.

The filler tube 30 connects the filler-neck body 50 of the filler neck 20 with the fuel tank 10. That is, the filler tube 30 is directly connected at one of the opposite ends to an outlet side of the filler neck 20, and is connected at the other one of the opposite ends to a side of the fuel tank 10. Note that, in some cases, the filler tube 30 may be connected directly at the other opposite end to the fuel tank 10. In some other cases, the filler tube 30 may be connected at the other opposite end to a connector (not shown) relaying the supplied liquid fuel to the fuel tank 10.

Moreover, inserting the nozzle 2a of the fueling gun 2 into the filler neck 20, and then supplying the liquid fuel through the nozzle 2a of the fueling gun 2 lead to passing the liquid fuel through the filler tube 30 and then holding it in the fuel tank 10.

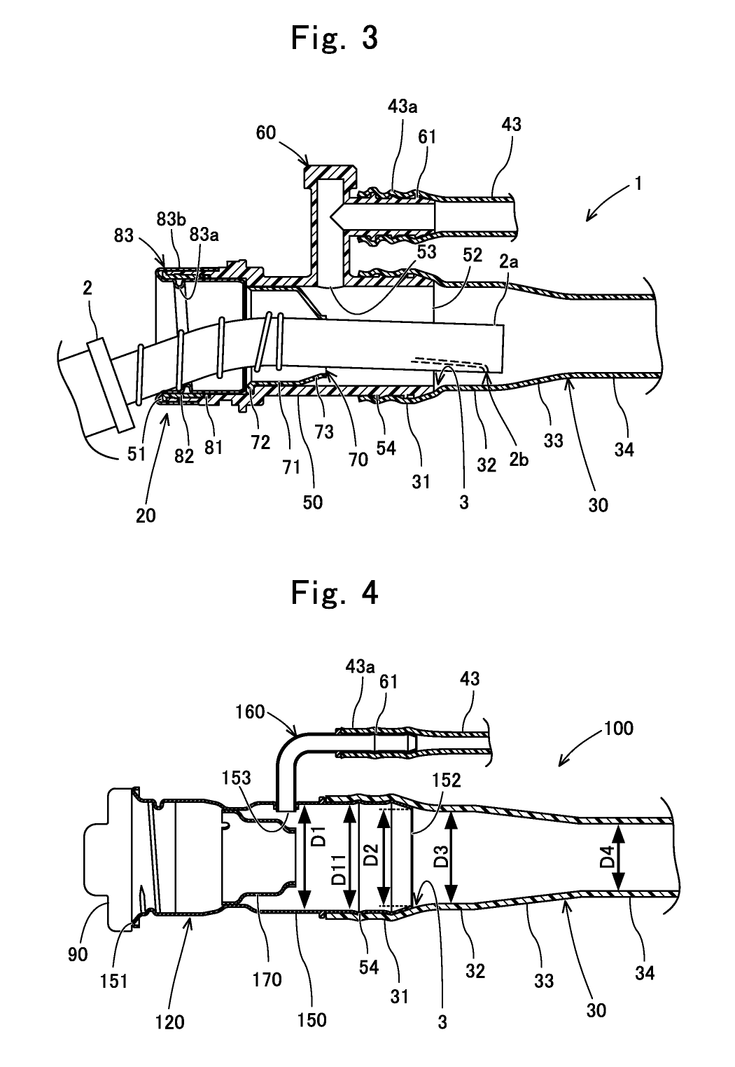

Note herein that, when the fuel tank 10 is fully filled up whit the liquid fuel, the liquid fuel, which is held in the filler tube 30 and which makes contact with the leading end in the nozzle 2a of the fueling gun 2, stops the supply of the liquid fuel through the nozzle 2a of the fueling gun 2 automatically (i.e., an auto-stopping function). In more detail, a pilot bore 2b (see FIG. 3) for detecting the liquid fuel is formed in the lower face of the nozzle 2a on the leading-end side. Thus, the liquid fuel clogging up the pilot bore 2b stops the supply of the liquid fuel through the fueling gun 2.

The breather line 40 connects the fuel tank 10 with the breather cylindrical portion 60 of the filler neck 20. The breather line 40 cakes a line for distributing fuel vapors or air within the fuel tank 10 from a side of the fuel tank 10 to the filler neck 20 upon supplying the liquid fuel to the fuel tank 10 by way of the filler tube 30.

The breather line 40 includes a cut-off valve device 41, a connector 42, and a breather tube 43. When the cut-off valve device 41 arranged on the top of the fuel tank 10 is opened, it discharges the fuel vapors or air within the fuel tank 10 to a side of the filler neck 20. The cut-off valve device 41 is provided with a metallic connection pipe.

The connector 42 is linked to the connection pipe of the cut-off valve device 41. For example, the connector 42 is constructed as a connector disclosed in Japanese Patent Gazette No. 3775656, and so on; or it is constructed so as to exclude the flow control valve from the connector. That is, the connector 42 is disposed detachably to and from the connection pipe of the cut-off valve device 41. The breather tube 43, which is made of a long-length tube or hose formed of resin, connects the connector 42 with the breather cylindrical portion 60 of the filler neck 20.

Moreover, when the fuel tank 10 is fully filled up with the liquid fuel and then the auto-stopping function is actuated while filling up the liquid fuel, the liquid fuel coming from the fuel tank 10 is refluxed or flowed back to the filler neck 20 by way of the breather tube 43. Thus, the breather tube 43 distributes fuel vapors during filling up the liquid fuel, and the refluxed liquid fuel when the fueling apparatus 1 is put on the auto-stopping mode.

### 1-2. Detailed Construction of Fueling Apparatus 1

How the fueling apparatus 1 illustrated in FIG. 1 is constructed at the filler neck 20 and at around the periphery of the filler neck 20 will be hereinafter described with reference to FIG. 2. The filler neck 20 includes a filler-neck body 50 made of resin, the breather cylindrical portion 60 made of resin, a nozzle guide 70 made of resin, a sealing member 81 made of rubber, a sealing-member retaining member 82, an end fitting 83 made of metal, and the filler cap 90.

The filler-neck body 50, which is made of resin, is formed as a cylindrical shape. In more detail, the filler-neck body 50 has a central axial line formed linearly, and an opening at the opposite ends. The filler-neck body 50 has an inlet 51 on one of the opposite sides located on a side of the automobile outer surface (i.e., on the left side in FIG. 2), and an outlet 52 on the other one of the opposite sides located on a side of the fuel tank 10 (i.e., on the right side in FIG. 2).

Into the inlet 51 of the filler-neck body 50, the nozzle 2a of the fueling gun 2 illustrated in FIGS. 1 and 3 is inserted. Through the outlet 52 of the filler-neck body 50 (which is equivalent to the outlet of the filler neck 20), the liquid fuel is supplied to the filler tube 30 illustrated in FIG. 1. Moreover, the filler-neck body 50 further includes a reflux port 53 at around the axial middle on the upper or lateral peripheral side.

The filler-neck body 50 has a first inner peripheral face formed in the shape of two-staged stairs extending from the inlet 51 toward the reflux port 53 over a first range of from a site of the inlet 51 to a site of the reflux port 53. Moreover, the filler-neck body 50 further has a second inner peripheral face formed to exhibit an identical diameter over a second range of from the site of the reflux port 53 to the outlet 52. That is, the filler-neck body 50 is formed to have the largest diameter at the inlet 51.

In addition, the filler-neck body 50 further includes a tube locking portion 54 formed on the outer peripheral face at one of the opposite sides which is more adjacent to the outlet 52 than is the reflux port 53. The tube locking portion 54 is formed in the shape of a bamboo shoot, namely, is formed as a shape having a plurality of protuberances and depressions in the axial direction. Around the tube locking portion 54, the fitable cylindrical portion 31, which is located at the inlet end of the filler tube 30, is fitted. Therefore, the tube locking portion 54 inhibits the filler tube 30 from coming off from the filler-neck body 50. Moreover, around one of the depressions in the tube locking portion 54, a not-shown O-ring is fitted. Thus, the O-ring seals between the tube locking portion 54 and the filler tube 30.

Note herein that the filler-neck body 50 has an inside diameter “D1” (corresponding to a first inside diameter) at the site of the reflux port 53. Moreover, the filler-neck body 50 is formed to have an inside diameter “D2” at the outlet 52. As described above, the filler-neck body 50 has the inner peripheral face exhibiting an identical diameter over the range of from the site of the reflux port 53 to the outlet 52. Therefore, the inside diameter “D1” at the site of the reflux port 53, and the inside diameter “D2” at the outlet 52 are an identical diameter with one another. Moreover, from another different point of view, the range of from the site of the reflux port 53 to the outlet 52 involves the site where the tube locking portion 54 is formed. That is, the inner peripheral face of the filler-neck body 50 is formed at the site, where the tube locking portion 54 is formed, to have an inside diameter (corresponding to a second inside diameter) being identical with the inside diameter “D1” at the site of the reflux port and with the inside diameter “D2” at the outlet 52. Moreover, the inside diameter “D1” at the site of the reflux port 53, and the inside diameter “D2,” which the filler-neck body 50 has at the outlet 52, are formed fully larger than that of a minor-diameter opening, which the nozzle guide 70 has at a later-described tapered portion 73.

The breather cylindrical portion 60 is formed of resin as a letter-“L”-shaped cylindrical shape. In First Embodiment, the breather cylindrical portion 60 is formed integrally with the filler-neck body 50 on an outer side in the peripheral face. The breather cylindrical portion 60 is connected at and end of the letter-“L” shape to the reflux port 53 of the filler-neck body 50. That is, the breather cylindrical portion 60.s formed at and end of the letter-“L” shape so as to extend outward from an outer peripheral face of the filler-neck body 50. Note that the breather cylindrical portion 60 is also extended satisfactorily at an end of the letter-“L” shape in a perpendicular direction relative to the central axial line of the filler-neck body 50; or it is even extended properly in a direction inclining relative to the central axial line of the filler-neck body 50.

Moreover, the breather tube 60 is formed at another end of the letter-“L” shape so as to be substantially parallel to the filler-neck body 50. In addition, the breather tube 60 is opened at another end of the letter-“L” shape in the same direction as the filler-neck body 50 is opened at the outlet 52. The breather cylindrical portion 60 is provided with a tube locking portion 61 formed at another end of the letter-“L” shape on the outer peripheral face. The tube locking portion 61 is formed in the shape of a bamboo shoot, namely, is formed as a shape having a plurality of protuberances and depressions in the axial direction. Around the tube locking portion 61, an end 43a of the breather tube 43 made of resin is fitted. On this occasion, the breather tube 43 with the diametrically enlarged end 43a is locked to the tube locking portion 61.

Therefore, the tube locking portion 61 inhibits the breather tube 43 from coming off from the breather cylindrical portion 60. Moreover, around one of the depressions in the tube looking portion 61, a not-shown O-ring is fitted. Thus, the O-ring seals between the tube locking portion 61 and the breather tube 43.

The nozzle guide 70, which is formed of resin as a cylindrical shape, guides the nozzle 2a of the fueling gun 2 to be inserted into the fuel-neck body 50 as shown in FIG. 1. The nozzle guide 70 is inserted inside the filler-neck body 50. The nozzle guide 70 is inserted into the filler-neck body 50 from the side of the inlet 51 until it is arranged at a site where it is located more adjacent to the side of the inlet 51 than the reflux port 53 is located.

The nozzle guide 70 includes a major-diameter portion 71, a flanged portion 72, and a tapered portion 73. The major-diameter portion 70 is formed as a substantially circular cylindrical shape which has an inside diameter substantially agreeing with the inside diameter that the filler-neck body 50 has at around the reflux port 53. The flanged portion 72 is formed to extend from an opening end of the major-diameter portion 71 radially outward. The flanged portion 72 buts against a stepped section on the inner peripheral face of the filler-neck body 50. Moreover, the flanged portion 72 and filler-neck body 50 are provided with not-shown irregular sections which lock to one another circumferentially. That is, the irregular sections position the flanged portion 72 in a predetermined phase with the filler-neck body 50.

The tapered portion 73 is formed so as to diametrically reduce from the major-diameter portion 71 to the side of the outlet 52 of the filler-neck body 50. The tapered portion 73 has a minor-diameter opening located at around the reflux port 53. Moreover, the minor-diameter opening of the tapered portion 73 is made to be eccentric relative to the major-diameter portion 71 in a direction getting away from the reflux port 53. That is, while the minor-diameter opening of the tapered portion 73 is separated greatly away from the reflux port 53, the minor-diameter opening is located adjacent to an opposing face that is across from the reflux port 53 in the inner peripheral face of the filler-neck body 50. Therefore, the tapered portion 73 has on the outer peripheral face a function of guiding the liquid fuel, which is discharged from the reflux port 53, to the side of the outlet 52 of the filler-neck body 50.

The minor-diameter opening of the tapered portion 73 has an inside diameter which is slightly larger the outside diameter of the nozzle 2a of the fueling gun 2 as shown in FIG. 3. That is, the minor-diameter opening gives the tapered portion 73 not only a function of guiding the nozzle 2a of the fueling gun 2 toward the minor-diameter opening of the tapered portion 73 but also another function of keeping the nozzle 2a of the fueling gun 2, which is inserted into the filler-neck body 50, in a stabilized state.

The sealing member 81 includes an annular member, such as an O-ring, for instance. The sealing member 81 is fitted into the inner peripheral face of the filler-neck body 50 on a side of the inlet 51. The sealing member 81 makes contact with a stepped end face which is located closest to the inlet 51 in the filler-neck body 50. The sealing-member retaining member 82, which is arranged on the side of the inlet 51 in the filler-neck body 50, is arranged more adjacent to the side of the inlet 51 than is the sealing member 81. That is, the sealing-member retaining member 82 and the flanged portion 72 of the nozzle guide 70, which clamp the sealing member 81 axially, position the sealing member 81.

The end fitting 83, which is formed as cylindrical shape, is installed to the inlet 51 of the filler-neck body 50. That is, the end fitting 83 has an opening which is equivalent to the inlet of the filler neck 20. The end fitting 83 has a function of preventing the nozzle 2a of the fueling gun 2 from directly making contact with the fuel-neck body 50 made of resin.

The end fitting 83 includes an inner peripheral portion 83a and outer peripheral portion 83b which are formed integrally with one another. The inner peripheral portion 83a of the end fitting 83 is located at a site on the side of the inlet 51 on an inner peripheral side of the filler-neck body 50, and is also located at a further inner site on an inner peripheral side of the sealing-member retaining member 82, The inner peripheral portion 83a of the end fitting 83, which makes contact with the flanged portion 72 of the nozzle guide 70, positions the nozzle guide 70.

Moreover, the inner peripheral portion 83a of the end fitting 83, which makes contact with the sealing member 81, prevents the liquid fuel from leaking to the outside through the interspace between the end fitting 83 and the filler-neck body 50. In addition, an internal thread, which is formed on the inner peripheral portion 83a of the end fitting 83, screws the end fitting 83 and filler cap 90 together. The outer peripheral portion 83b of the end fitting 83 is located at a site on the side of the inlet 51 on an outer peripheral side of the filler-neck body 50.

An external thread, which is formed on an outer peripheral face of the filler cap 90, is screwed with the internal thread of the end fitting 83. The filler cap 90 blocks up the end fitting 83 at the opening, namely, the filler neck 20 at the inlet.

The filler tube 30, which is made of resin, connects the filler-neck body 50 with the fuel tank 10. The filler tube 30 will be hereinafter described in detail while focusing on its parts at which it is connected with the filler-neck body 50. The filler tube 30 includes a fitable cylindrical portion 31, a major-diameter straight portion 32, a tapered cylindrical portion 33, and a minor-diameter cylindrical portion 34.

The fitable cylindrical portion 31 is located at one of the farthest ends in the filler tube 30. The fitable cylindrical portion 31 is fitted around the tube locking portion 54 which is formed on an outer peripheral face of the filler-neck body 50 on a side of the outlet 52. Before the fitable cylindrical portion 31 is fitted around the tube locking portion 54, it has an inside diameter which is slightly smaller than the outside diameter of the tube locking portion 54. Therefore, the fitable cylindrical portion 31, which is fitted around the tube locking portion 54 to be diametrically enlarged, prevents the filler tube 30 from coming off from the filler-neck body 50.

The major-diameter straight cylindrical portion is connected to the fitable cylindrical portion 31 continuously to and from it. The major-diameter straight cylindrical portion 32, which is formed straight or in the shape of a straight pipe, namely, whose central axial line is formed linearly, has an identical diameter over the axial entire length. The major-diameter straight cylindrical portion 32 is formed as the same configuration as that of the fitable cylindrical portion 31 before being fitted around the tube locking portion 54. That is, the major-diameter straight cylindrical portion 32 functions as a site for adjusting a fitable length which the fitable cylindrical portion 31 exhibits.

The major-diameter cylindrical portion 32 has an inside diameter “D3.” The inside diameter “D3” of the major-diameter cylindrical portion 32 is comparable to the inside diameter “D2” of the filler-neck body 50 at the inlet 52. The inside diameter “D3” of the major-diameter cylindrical portion 32 is also satisfactorily to be identical with the inside diameter “D2”; it is even properly to be slightly larger than the inside diameter “D2”; or it is also satisfactorily to be slightly smaller than the inside diameter “D2.” The inside diameter “D3” of the major-diameter cylindrical portion 32 is set up so as to make the fitable cylindrical portion 31 fitable around the filler-neck body 50, and to make the fitable cylindrical portion 31 exert the locking force of a predetermined value or more to the tube locking portion 54.

The tapered cylindrical portion 33 is connected to the major-diameter cylindrical portion 31 continuously to and from it. The tapered cylindrical portion 33 has the central axial line formed linearly. The tapered cylindrical portion 33 is formed to have a major diameter on one of the opposite sides adjacent to the major-diameter straight cylindrical portion 32, but is formed to have a minor diameter on the other one of the opposite sides across from the major-diameter straight cylindrical portion 32. That is, the tapered cylindrical portion 33 has an inside diameter, which is identical with the inside diameter “D3” of the major-diameter straight cylindrical portion 32, on the major-diameter side. Moreover, the tapered cylindrical portion 33 is formed coaxially relative to the fitable cylindrical portion 31 and major-diameter straight cylindrical portion 32.

The tapered cylindrical portion 33 has a function equivalent to that of the tapered part in a conventional filler neck (i.e., a member corresponding to the filler neck 20 according to First Embodiment). That is, the tapered cylindrical portion 33 makes a linkage part for favorably distributing the liquid fuel from the filler neck 20 to the minor-diameter cylindrical portion 34.

The minor-diameter cylindrical portion 34 makes a part accounting for most of the filler tube 30 at the axial middle. That is, the minor-diameter portion 34 is located at most of the interspace between the filler neck 20 and the fuel tank 10. The minor-diameter cylindrical portion 34 is connected to the tapered cylindrical portion 33 on the minor-diameter side continuously to and from it. That is, the minor-diameter cylindrical portion 34 is formed to have a minor diameter which is smaller than those of the fitable cylindrical portion 31 and major-diameter straight cylindrical portion 32.

Note herein that the min diameter cylindrical portion 34 has an inside diameter “D4” That is, the inside diameter “D4” of the minor-diameter cylindrical portion 34 is smaller than the inside diameter “D2” of the filler-neck body 50 at the outlet 52, and is smaller than the inside diameter “D3” of the major-diameter straight cylindrical portion 32. The inside diameter “D4” of the minor-diameter cylindrical portion 34 is formed at a predetermined inside diameter which is set up based on a condition under which the liquid fuel is distributed from the filler neck 20 to the fuel tank 10. For example, the inside diameter “D4” of the minor-diameter cylindrical portion 34 is set up so that a flow volume of the liquid fuel, which is distributed through the minor-diameter cylindrical portion 34, is a predetermined volume or more per unit time.

Moreover, the minor-diameter cylindrical portion 34 also satisfactorily has the central axial line formed linearly, or even properly has the central axial line formed curvedly or flexurally. The central axial line of the minor-diameter cylindrical portion 34 has a configuration designed freely depending on locations at which the filler neck 20 and fuel tank 10 are present. In particular, the axial line of the minor-diameter cylindrical portion 34 is also satisfactorily formed so as to curve or flex right after the part connected to the minor-diameter side of the tapered cylindrical portion 33, or is even properly formed linearly by an arbitrary or discretional length so as to extend coaxially relative to the tapered cylindrical portion 33.

### 1-3. Grooved Portion 3

Next, a grooved portion 3, which is formed at a site connecting the filler neck 20 with the filler tube 30, will be hereinafter described with reference to FIG. 2. The fitable cylindrical portion 31 of the filler tube 30 is fitted around the outer peripheral face of the outlet 52 of the filler-neck body 50 composing the filler neck 20. Consequently, the grooved portion 3 is formed annularly between an end face in the outlet 52 of the filler-neck body 50 and an inner peripheral face in the filler tube 30. The grooved portion 3 according to First Embodiment is formed at an axial interspace between the major-diameter straight cylindrical portion 32 and the end face of the filler-neck body 50 on the side of the outlet 52.

Note herein that the liquid fuel is distributed smoothly between the sites at which the reflux port 53 and outlet 52 are formed, because the inner peripheral face of the filler-neck body 50 is formed to have an identical diameter “D1” and/or “D2” at the sites, respectively. Moreover, the liquid fuel is distributed smoothly over a range coming from the major-diameter straight cylindrical portion 32 of the filler tube 30 and arriving at the minor-diameter cylindrical portion 34 by way of the tapered cylindrical portion 33, because the inner peripheral face of the filler tube 30 changes smoothly over the range.

The grooved portion 3 discontinuously connects the inner peripheral face of the filler-neck body 50 at around the outlet 52 with the inner peripheral face of the filler tube 30. Consequently, the grooved portion 3 makes a site causing obstructions to the distribution of the liquid fuel. For example, the grooved portion 3 becomes causes for vortex flows or backward flows in the liquid fuel.

### 1-4. Fueling Apparatus 1 when Filling Up Liquid Fuel

Next, the fueling apparatus 1 at the time of filling up the liquid fuel will be hereinafter described with reference to FIG. 3. To fill up the liquid fuel, the filler cap 90 is removed to open the filler neck 20 at the inlet. The nozzle 2a of the fueling gun 2 is inserted into the inlet of the filler neck 20. The nozzle 2a of the fueling gun 2 comes in contact with the tapered portion 73 of the nozzle guide 70, and then passes over the minor-diameter opening in the tapered portion 73 of the nozzle guide 70. Moreover, the nozzle 2a of the fueling gun 2, which is inserted into the filler neck 20 to the innermost as shown in FIG. 3, puts the fueling gun 2 in a fully inserted state.

When the fueling gun 2 is fully inserted as described above, the leading end of the nozzle 2a is located in a range of the axial interspace between the major-diameter straight cylindrical portion 32 and tapered cylindrical portion 33 of the filler tube 30. That is, the grooved portion 3 is located more adjacent to the inlet side of the filler neck 20 than is the leading end of the nozzle 2a that is fully inserted.

The liquid fuel, which is discharged from the nozzle 2a of the fueling gun 2, is headed from the opening in the nozzle 2a toward the minor-diameter cylindrical portion 34 of the filler tube 30. On this occasion, the liquid fuel spreads from the opening of the nozzle 2a. Then, some of the liquid fuel hits against the tapered cylindrical portion 33. However, the liquid fuel, which has hit against the tapered cylindrical portion 33, is headed toward the minor-diameter cylindrical portion 34 along the tapered cylindrical portion 33. Thus, the liquid fuel, which is discharged from the nozzle 2a, does not directly hit against the grooved portion 3 at all, because the grooved portion 3 is located more adjacent to the inlet side of the filler neck 20 than is the leading end of the nozzle 2a.

Note herein that the nozzle 2a of the fueling gun 2 is provided with a pilot hole 2b, which is intended to detect auto-stopping, in the lower face on the leading end side. That is, the pilot hole 2b is formed at a location apart from the leading end of the nozzle 2a by a distance. Specifically, the pilot bore 2b is located in an axial range of from the major-diameter straight cylindrical portion 32 of the filler tube 30 to the tapered cylindrical portion 33. In other words, the grooved portion 3 is located on a side more adjacent to the inlet side of the filler neck 20 than is the pilot hole 2b when the nozzle 2a is fully inserted into the filler neck 20.

When the fuel tank 10 is fully filled up with the liquid fuel so that the liquid fuel fills up to the location of the pilot hole 2b, the liquid fuel shuts off the distribution of air through the pilot hole 2b. If so, the fueling apparatus 1 actuates the auto-stopping function to stop the fueling gun 2 supplying the liquid fuel. Note herein that, even when the fuel tank 10 is not fully filled up with the liquid fuel, the liquid fuel, which is discharged from the nozzle 2a and is bounced back to intrude into the pilot hole 2b, might actuate the auto-stopping function. However, even when the liquid fuel, which is discharged from the nozzle 2a, has hit against the tapered cylindrical portion 33, the liquid fuel hardly bounces back toward a side of the pilot hole 2b as described above. Therefore, the liquid fuel, which bounces back, scarcely actuates the auto-stopping function.

In particular, the filler tube 30 includes the major-diameter straight cylindrical portion 32 disposed between the fitable cylindrical portion 31 and the tapered cylindrical portion 33. Therefore, the grooved portion 3 is formed between the major-diameter straight cylindrical portion 32 and the end face of the filler neck 20 on the outlet side. Thus, when the liquid fuel, which is discharged from the nozzle 2a, bounces back at the tapered cylindrical portion 33, the major-diameter cylindrical portion 32 smoothes the flow of the liquid fuel directionally before the liquid fuel reaches the grooved portion 3. As a result, the presence of the major-diameter cylindrical portion 32 also makes the liquid fuel little bounce back toward the pilot hole 2b.

Note herein that the grooved portion 3 does not exist in the vicinity of the pilot hole 2b. Accordingly, even if the liquid fuel, which is discharged from the nozzle 2a, should have bounced back at the tapered cylindrical portion 33, the liquid fuel hardly bounces back secondarily around the pilot hole 2b. Consequently, the liquid fuel comes to be headed toward the pilot hole 2b in a very small amount. Therefore, the location of the grooved portion 3 also leads to inhibiting the liquid fuel, which bounces back, from actuating the auto-stopping function.

Moreover, the fuel liquid flows from the reflux port 53 into the interior of the filler-neck body 50 by way of the breather tube 43. The liquid fuel, which has come to be refluxed, is distributed from the reflux port 53 to the outlet side of the filler neck 20, namely, to the side of the outlet 52 in the filler-neck body 50. However, the refluxed liquid fuel is less than the liquid fuel discharged from the nozzle 2a. Consequently, the refluxed liquid fuel, which is headed toward the pilot hole 2b, accounts for a negligible amount of the entire refluxed liquid fuel.

Note herein that the grooved portion 3 might possibly disperse the refluxed liquid fuel. However, the grooved portion 3 is separated away from the pilot hole 2b. Accordingly, most of the liquid fuel dispersed by the grooved portion 3 is not headed toward the pilot hole 2b at all. Consequently, the refluxed liquid fuel does not actuate the auto-stopping function at all.

1-5. Usefulness in Laying Out Filler Piping

Next, usefulness of the fueling apparatus 1 according to First Embodiment in laying out filler piping will be hereinafter described with reference to FIGS. 2 and 3. As illustrated in the drawings, the filler neck 20 is formed in the shape of a substantially cylindrical shape. The filler tube 30 includes the tapered cylindrical portion guiding the distribution of the liquid fuel to the minor-diameter cylindrical portion 34. That is, the inside diameter “D2” of the outlet in the filler neck 20 (i.e., the outlet 52 in the filler-neck body 50) is formed larger than the inside diameter “D4” of the minor-diameter cylindrical portion 34 of the filler tube 30. The fueling apparatus 1 has such a novel structure that is equivalent to a structure in which the diametrically reduced part composing a conventional filler neck is shifted or transferred to a side adjacent to the filler tube 30.

That is, it is hardly needed to ensure a length for the inner peripheral face of the filler neck 20 from the site of the reflux port 53 up to that of the outlet 52. In more detail, the inner peripheral face of the filler neck 20 is formed to have an identical diameter “D1” and/or “D2” over a range from the site of the reflux port 53 to that of the outlet 52. That is, the inside diameter “D1” at the site of the reflux port 53 is identical with the inside diameter “D2” at the site of the outlet 52 as well as with the inside diameter at the site around which the fitable cylindrical portion 31 is fitted.

Meanwhile, it is needed to form the tube locking portion 54 in a length which allows it to surely exert a locking force to the fitable cylindrical portion 31 of the filler tube 30. Therefore, the length from the reflux port 53 to the outlet 52 in the filler-neck body 50 depends on the length of the tube locking portion 54. In other words, it is possible to set the length from the reflux port 53 to the outlet 52 at the shortest length which enables the locking portion 54 to surely exert a locking force to the fitted cylindrical portion 31.

Therefore, shortening the filler neck 20 is possible. Moreover, when the nozzle 2a of the fueling gun 2 is fully inserted, t sticks out from out of the outlet of the filler neck 20, as shown in FIG. 3. Thus, the filler neck 20 has such a short overall length.

However, the fitable cylindrical portion 31, major-diameter cylindrical portion 32 and tapered cylindrical portion 33 of the filler tube 30 have the central axial line which is formed linearly. That is, the fueling apparatus 1 according to First Example is formed linearly from the filler neck 20 and up to the tapered cylindrical portion 33.

Thus, even the filler tube 30 having the central axial line, which is formed linearly from the inlet end to the tapered cylindrical portion 33, allows the minor-diameter cylindrical portion 34 of the filler tube 30 to have the central axial line which is flexed or bent at around the part to be connected to the tapered cylindrical portion 33, or to have the central axial line which is formed linearly. That is, the filler tube 30 permits the minor-diameter cylindrical portion 34 to have a free configuration over the entire length. That is, the filler tube 30 allows forming a part, which is equivalent to a minor-diameter part of a filler neck having the conventional structure, to be flexed or bent. The result is an upgraded degree of freedom in laying out the filler piping of the fueling apparatus 1 according to First Embodiment, namely, the filler-neck body 20 and/or the filler tube 30.

### 2. Second Embodiment

First Embodiment comprises the filler tube 30 including the major-diameter cylindrical portion 32 disposed between the fitable cylindrical portion 31 and the tapered cylindrical portion 33. Second Embodiment is however free of the major-diameter cylindrical portion 32. That is, the filler tube 30 according to Second Embodiment includes the fitable cylindrical portion 31, and the tapered cylindrical portion 33 connected on the major-diameter side directly to the fitable cylindrical portion 31.

Second Embodiment shortens the length from the inlet of the filler neck 20 and up to the tapered cylindrical portion 33 of the filler tube 30. Thus, the minor-diameter cylindrical portion 34 enabled to have a free configuration furthermore upgrades a degree of freedom in laying out the filler piping, namely, the filler-neck body 20 and/or the filler tube 30.

### 3. Third Embodiment

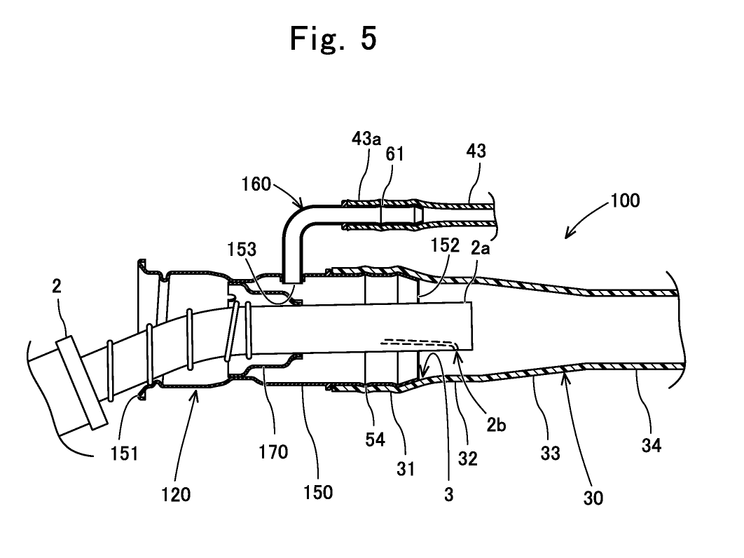

A fueling apparatus 100 according to Third Embodiment will be hereinafter described with reference to FIGS. 4 and 5. The fueling apparatus 100 comprises the fuel tank 10, a filler neck 120, the filler tube 30, and the breather line 40. The filler neck 120 includes a filler-neck body 150 made of metal, a breather cylindrical portion 160, a nozzle guide 170 made of metal, and the filler cap 90.

The filler-neck body 150 made into an integrated member by metal at parts which are equivalent to the filler-neck body 50 and end fitting 83 according to First Embodiment. The inner peripheral face of the filler-neck body 150 is formed to have an inside diameter “D1” (corresponding to a first inside diameter) at the site of a reflux port 153, and an inside diameter “D11” (corresponding to a second inside diameter) at the site around which the fitable cylindrical portion 31 of the filler tube 30 is fitted, the inside diameters “D1” and “D11” being identical with one another. Note herein that the site around which the fitable cylindrical portion 31 is fitted involves the following: the guide part for making the inlet end of the filler tube 30 likely to insert; the protuberances and depressions (or irregularities) for locking the filler-neck body 150 to the fitable cylindrical portion 31; and the cylindrical part for ensuring a fitted length. The inside diameter “D11” at the site around which the fitable cylindrical portion 31 is fitted is equivalent to an inside diameter which the fitted-length ensuring cylindrical part (or the tube locking portion 54) has.

Meanwhile, the filler-neck body 150 has at the outlet 152 an inside diameter “D2,” which is smaller than the inside diameters “D1” and “D11,” in order to ensure the provision of the guide part. However, the inside diameter “D2” of the outlet 152 is larger than the inside diameter “D3,” which the filler tube 30 has at the major-diameter straight cylindrical portion 32, and the inside diameter “D4” at the minor-diameter cylindrical portion 34.

The breather cylindrical portion 160, which is formed in the shape of a letter “L,” is integrally joined to the filler-neck body 150. Moreover, the nozzle guide 170 is integrally joined to the filler-neck body 150 internally. Note that various joining methods, such as welding and adhesion like brazing, for instance, are applicable to the method of joining the breather cylindrical portion 160 and nozzle guide 170 to the filler-neck body 150.

The fueling apparatus 100 according to Third Embodiment as well produces the same advantages as those of the fueling apparatus 1 according to First Embodiment. That is, the fueling apparatus 100 has a shortened length from the inlet 151 of the filler neck 120 and up to the tapered cylindrical portion 33 of the filler tube 30. Therefore, the minor-diameter cylindrical portion 34 enabled to have a free configuration furthermore upgrades a degree of freedom in laying out the filler piping, namely, the filler-neck body 120 and/or the filler tube 30.

Moreover, the filler-neck body 150, which is made of metal, allows making the thickness of the filler-neck body 150 thinner than that of the filler-neck body 50 made of resin. Consequently, a shallow depth is given to the grooved portion 3 formed between the end face in the outlet 152 of the filler-neck body 150 and the inner peripheral face of the filler tube 30. The shallow depth results in making the grooved portion 3 much less likely to affect adversely than the grooved portion 3 does in First Embodiment That is, the grooved portion 3 with a shallow depth much more inhibits the liquid fuel, which bounces back at the grooved portion 3, from actuating the auto-stopping function.

What is claimed is:

1. A fueling apparatus comprising:
a filler neck which is formed as a cylindrical shape, and into which a nozzle of a fueling gun is inserted through an inlet side thereof; and
a filler tube connected at one of opposite ends thereof to an outlet side of the filler neck, and connected at another one of the opposite ends to a side of a fuel tank;
the filler tube including:
a fitable cylindrical portion fitted around an outer peripheral face on the outlet side of the filler neck;
a tapered cylindrical portion formed to have a major diameter on one of opposite sides thereof adjacent to the fitable cylindrical portion, and formed to have a minor diameter on another one of the opposite sides across from the fitable cylindrical portion; and
a minor-diameter cylindrical portion connected to the tapered cylindrical portion on the minor-diameter side, formed to have a minor diameter which is smaller than that of the fitable cylindrical portion, and formed to have a predetermined inside diameter which is set up based on a fuel distribution condition from the filler neck to the fuel tank;
the filler neck formed to have an outlet inside diameter which is larger than the predetermined inside diameter in the minor-diameter cylindrical portion of the filler tube.

2. The fueling apparatus according to claim 1, wherein an end face on the outlet side of the filler neck, and an inner peripheral face of the filler tube form an annular grooved portion.

3. The fueling apparatus according to claim 2, wherein:
the filler tube further includes a major-diameter straight cylindrical portion connected at one of opposite ends thereof to the fitable cylindrical portion, and connected at another one of the opposite ends to a major diameter side of the tapered cylindrical portion, and formed as a straight shape; and
the annular grooved portion is formed in an axial interspace between an end face on an outlet side of the filler neck and the major-diameter straight cylindrical portion.

4. The fueling apparatus according to claim 2, wherein the annular grooved portion is located more adjacent to an inlet side of the filler neck than is a leading end in the nozzle of the fueling gun which is fully inserted into the filler neck.

5. The fueling apparatus according to claim 4, wherein:
the nozzle of the fueling gun includes a pilot hole for auto-stopping detection; and
the annular grooved portion is located more adjacent to an inlet side of the filler neck than is the pilot hole in the nozzle of the fueling gun which is fully inserted into the filler neck.

6. The fueling apparatus according to claim 1 further comprising a breather tube connected at one of opposite ends thereof to the filler neck, connected at another one of the opposite ends to a side of the fuel tank, and distributing fuel vapors or air from the side of the fuel tank to the filler neck;
the filler neck includes a reflux port formed in a cylindrical peripheral face thereof, and letting in the fuel vapors or the air from the breather tube to a cylindrical interior in the filler neck;
the filler neck has a first inside diameter at a site of the reflux port in an inner peripheral face thereof, and further has a second inside diameter at a site around which the fitable cylindrical portion is fitted;
the first inside diameter, and the second inside diameter are formed in an identical diameter with one another.

7. The fueling apparatus according to claim 6, wherein the inner peripheral face of the filler neck is formed to have an identical diameter over a range of from the site of the reflux port to the outlet.
